(19) United States
(12) Patent Application Publication
(10) Pub. No.: US 2008/0077690 A1
(43) Pub. Date: Mar. 27, 2008

(54) System, method, and program for reducing server load

(75) Inventor: Hiroaki Miyajima, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/898,301

(22) Filed: Sep. 11, 2007

(30) Foreign Application Priority Data
Sep. 27, 2006 (JP) 2006-261956

(51) Int. Cl. G06F 15/173

(52) U.S. Cl. 709/226

(57) ABSTRACT

According to a present invention, there is provided a first computer, which comprises a client manager that sends resource information on resources of the first computer to a second computer, and gets a server generated based on the resource information from the second computer for execution.

This application is based on Japanese Patent Application No. JP 2006-261956 filed on Sep. 27, 2006, and including a specification, claims, drawings and summary. The disclosure of the above Japanese Patent Application is incorporated herein by reference in its entirely.

### BACKGROUND OF THE INVENTION

1. Field of the Invention

The present invention relates to a load reducing system, more particularly to a load reducing system for reducing the load of a server by utilizing a client.

2. Description of the Related Art

JP-A No. 2004-220151 (patent document 1) discloses a server machine having a switching function for switching an old module to a new module.

According to the patent document 1, the server machine loads a target module to be activated in a memory receiving a file activation command. This server machine includes the following elements.
1. A virtual server controller for generating a virtual client OS for each target module to be activated, stored in a memory unit
2. A boot controller for activating each of the target modules to be activated
3. An IP address/module name translation DB manager for setting an IP address to each target module to be activated, registering a relationship between the name of the target module and the IP address in a first table, and making translation between the module name and the IP address
4. A routing controller for routing a message addressed to a module activated by another virtual client OS based on the IP address registered in the first table of the module

In other words, both a virtual server and a virtual client are running in a same server machine and the virtual server controller (hypervisor) intermediates IP addresses between them.

JP-A No. 11-053326 (patent document 2) also discloses a distributed processing system.

According to this technique, a client node sends a processing request signal to a server node in response to an operation of the user. Upon receiving the request signal, the server node obtains a CPU usage rate from an operating system. And if the CPU usage rate is under a preset value, the server node executes the requested processing and sends the processing result to the client node. If the CPU usage rate is over the preset value, the server node sends a response signal to the client node. The response signal instructs the client node to execute the requested processing. Receiving the response, the client node requests the server node to send an application program required for the processing. Upon receiving this request, the server node sends the application program for executing the requested processing to the client node. The client node then executes the application program to obtain a processing result. This means that the server node, upon receiving a search request from the client node, sends a searching program to the client node. Receiving the searching program, the client node executes the searching program. In this technique, the client functions and the search program do not run in any VMs (virtual machines).
[Patent document 1] JP-A No. 2004-220151
[Patent document 2] JP-A 11-053326

### SUMMARY OF THE INVENTION

It is an object of the present invention to provide a load reducing system capable of reducing the load of a server to which accesses are concentrated by utilizing a client PC.

According to a present invention, there is provided a first computer, which comprises a client manager that sends resource information on resources of the first computer to a second computer, and gets a server generated based on the resource information from the second computer for execution.

According to a present invention, there is provided a first computer, which comprises a means for sending resource information on resources of the first computer to a second computer; and a means for getting a server generated based on the resource information from the second computer for execution.

According to a present invention, there is provided a second computer, which comprises a server manager that receives resource information on resources of a first computer from the first computer; and a server generator that generates a server based on the resource information and sends the server to the first computer for execution.

According to a present invention, there is provided a second computer, which comprises a means for receiving resource information on resources of a first computer from the first computer; and a means for generating a server based on the resource information and sending the server to the first computer for execution.

According to a present invention, there is provided a signal-bearing medium tangibly which embodies a program of machine-readable instructions executable by a first computer to perform a sending process for sending resource information on resources of the first computer to a second computer; and a getting process for getting a server generated based on the resource information from the second computer for execution.

According to a present invention, there is provided a signal-bearing medium tangibly embodying a program of machine-readable instructions executable by a second computer to perform a receiving process for receiving resource information on resources of a first computer from the first computer; and a generating process for generating a server based on the resource information and send the server to the first computer for execution.

According to a present invention, there is provided a method for a first computer, which comprises sending resource information on resources of the first computer to a second computer; and getting a server generated based on the resource information from the second computer for execution.

According to a present invention, there is provided a method for a second computer, which comprises receiving resource information on resources of a first computer from the first computer; and generating a server based on the resource information and sending the server to the first computer for execution.

### BRIEF DESCRIPTION OF THE DRAWINGS

Exemplary features and advantages of the present invention will become apparent from the following detailed description when taken with the accompanying drawings in which:

FIG. 1 is a block diagram of a configuration of the present invention;

FIG. 2 is a diagram for showing how each server function module is generated;

FIG. 3 is a flow chart of processes of the present invention;

FIG. 4 is a diagram for describing a start-up of a virtual machine (VM) which provides an operation environment including a server environment;

FIG. 5 is a diagram for showing an example of a forward table;

FIG. 6 is a diagram for showing the first example of an AP server;

FIG. 7 is a diagram for showing a forward table in the first example of an AP server;

FIG. 8 is a diagram for showing the second example of an AP server;

FIG. 9 is a diagram for showing a forward table in the second example of an AP server;

FIG. 10 is a diagram for showing an example of a VPN server;

FIG. 11 is a diagram for showing a forward table in the example of a VPN server;

FIG. 12 is a diagram for showing an example of a PI server;

FIG. 13 is a diagram for showing a forward table in the example of a PI server;

FIG. 14 is a first diagram for showing a communication after a forward table is registered;

FIG. 15 is a second diagram for showing a communication after the forward table is registered;

FIG. 16 is a flowchart of an exchanger for processing a communication from a VM (client) using the forward table;

FIG. 17 is a flowchart of an exchanger for processing a communication from a VM (server) using the forward table;

FIG. 18 is a diagram for describing how a user requests downloading of a server program directly from a VM (client) to a client manager;

FIG. 19 is a diagram for showing an off-line state in which a client machine is disconnected from a network;

FIG. 20 is a diagram for showing the client manager which has a program cache on a disk;

FIG. 21 is a sequence chart for showing the operation of the present invention;

FIG. 22A is a sequence chart for showing an operation to end a VM (server);

FIG. 22B is a sequence chart for showing how a VM (server) is temporarily stopped and restarted;

FIG. 23 is a diagram for showing how a server function module is generated;

FIG. 24 is a schematic diagram for showing an example of remote calling;

FIG. 25 is a diagram for showing how a function module of a server is generated;

FIG. 26 is a diagram for showing how a function module of a VPN server is generated;

FIG. 27 is a diagram for showing how a function module of a PI server is generated;

FIG. 28 is a diagram for showing an example of an AP server; and

FIG. 29 is a diagram for showing how a function module of an AP server is generated.

### DESCRIPTION OF THE EXEMPLARY EMBODIMENTS

Hereunder, a first exemplary embodiment of the present invention will be described with reference to the accompanying drawings.

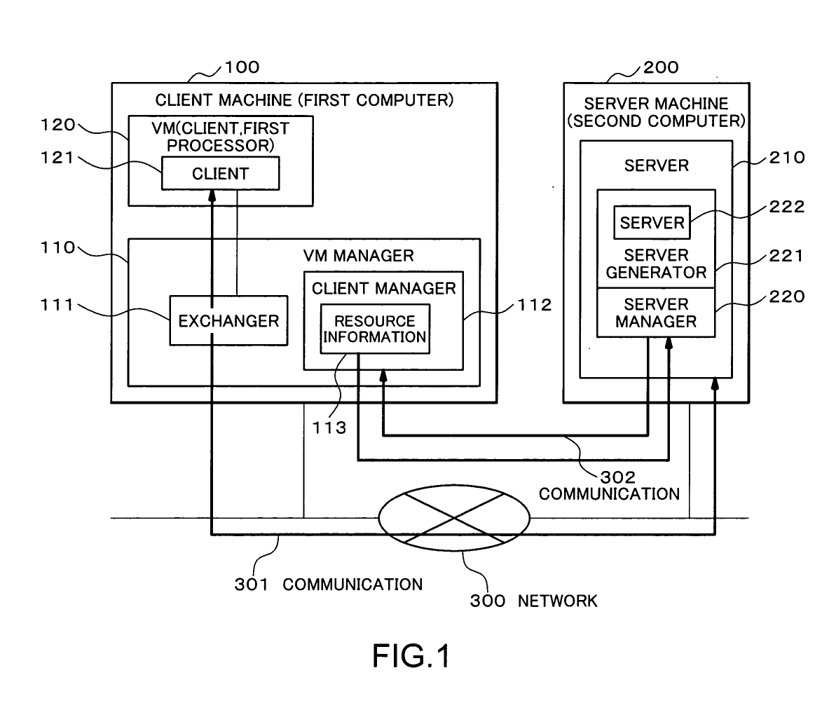

FIG. 1 shows a load reducing system of the present invention. The load reducing system includes a client machine 100, a server machine 200, and a network 300.

The client machine 100 includes a VM (virtual machine) manager 110 and a VM (Client, First Processor). The server machine 200 includes a server 210. The network 300 is a communication line for connecting the client machine 100 and the server machine 200 to each other. The network 300 may be any of a wired network and a wireless network.

The VM manager 110 is, for example, a virtual machine monitor (VMM), a hypervisor, or an application program for realizing a virtual machine (VM). The client machine 100 may always include the VM manager 110. The client machine 100 may obtain the VM manager 110 from the server machine 200 when the client machine 100 accesses the server machine 200. The VM manager 110 is obtained, for example, by downloading an application program that functions as the VM manager 110, as well as environmental parameters.

The VM manager 110 also includes an exchanger 111 and a client manager 112. The client manager 112 manages the client machine 100.

The exchanger 111 usually outputs packets inputted from the virtual machine (VM) 120 to the network 300. The exchanger 111 can output packets inputted from the virtual machine (VM) 120 to another machine belonging to the client machine 100 under a certain condition. The exchanger 111 usually outputs packets inputted from the network 300 to the virtual machine (VM) 120. The exchanger 111 can output packets inputted from another virtual machine belonging to the client machine 100 to the virtual machine (VM) 120 on a certain condition. Another virtual machine (VM) mentioned above operates under the control of the client machine 100 and it is other than the virtual machine (VM) 120.

The client manager 112 includes resource information 113 related to the resources (OS, CPU, memory, storage, network, etc.) available in a virtual machine (VM). This means that the client manager 112 manages machine resources of the client machine 100, which are available to the virtual machine (VM) A client 121 is a client OS that can run directly in the client machine 100 or a combination of the client OS and an application program that runs on the client OS. In other words, the client 121 is, for example, a client OS or the like that ran in the client machine 100 before the present invention was made. In this first embodiment, the client 121 is executed in the virtual machine (VM) 120. The virtual machine (VM) 120 may always include the client 121. It is also possible for the virtual machine (VM) 120 to obtain an application program equivalent to the client 121 and environment parameters from the server machine 200 by downloading, etc.

The server machine 200 executes the server 210. This server 210 includes a server manager 220 and a server generator 221. The server manager 220 manages the server machine 200. The server generator 221 generates the server 222.

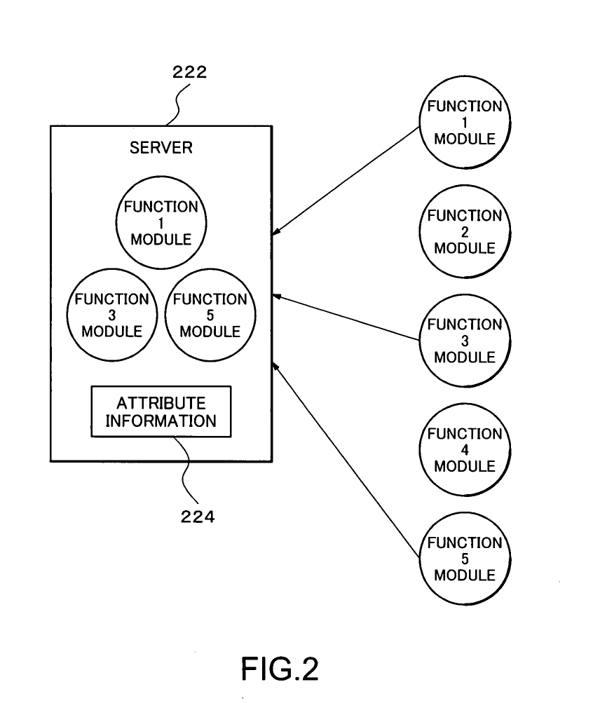

The server 222 is a program generated in the server machine 200 and sent to the client machine 100. The server 222 is executed by the virtual machine (VM) 130 in the client machine 100. The virtual machine (VM) 130 is created as needed in the client machine. 100. As shown in FIG. 2, the functions of the server 222 are determined based on the resource information 113 obtained from the client manager 112 and indicating the available resource of the client machine 100, and also based on the requirement of the client 121, and then modules for realizing those functions are collected to generate a server 222. The server generator 221 generates the server 222. The server generator 221 has attribute information 224 included in the server 222 upon generating the server 222. The server generator 221 is a combination of a storage and a processor (ex., CPU) for determining functions to be included in the server 222 based on the resource information 113. The storage is, for example, a memory for storing modules for realizing functions to be included in the server 222, as well as the attribute information 224.

In FIG. 2, the server generator 221 selects functions 1, 3, and 5 from among the functions 1 to 5 and generates the server 222 that includes modules for realizing those functions, as well as the attribute information 224. The functions 1, 3, and 5 are determined to be executable in the client machine 100 based on the resource information 113.

When the server machine 200 sends the client 121 to the client machine 100, the server generator 221 may also generate the client 121 based on the resource information 113 obtained from the client manager 112 and indicating the available resource of the client machine 100, and also based on the requirement of the client 121.

The server generator 221 determines modules to be selected from among the functions of the server 210 and included in the server 222 according to the following conditions.
(1) Resource information 113 obtained from the client manager 112
(2) Requirement of the client 121
(3) Location of data (for example, a module that requires data that cannot be transferred from the server machine 200 to the client machine 100 cannot be included in the server 222)
(4) Processing of common resources (ex., if a module to be executed in a single server machine 200 for exclusive controlling is being executed in another server machine 200, the module cannot be included in the server 222.)

Functions of a module that is not included in the server 222 sent to a client machine 100 may be performed by the server 210 in the server machine 200 or may be performed by another server 222 sent to another client machine 100.

The network 300 is, for example, an IP network and each of the communications 301 and 302 means a communication executed through the network 300.

Now, the present invention will be described in detail.

As shown in FIG. 1, a client 121 begins a communication 301 to request a service from a server 210. Receiving the service request, the server manager 220 in the server 210 connects to the client manager 112 of the client machine 100 through the communication 302. The server manager 220 may also connect to the client manager 112 not only when the client 121 requests a service, but also when the server 210 detects starting of the client 121 or when the load of the server 210 reaches a pre-determined level. The client manager 112, after being authenticated at the time of connection, sends the resource information 113 indicating resource available for the virtual machine (VM) 130 to the server manager 220. During this time, the client 121 receives the service from the server 210.

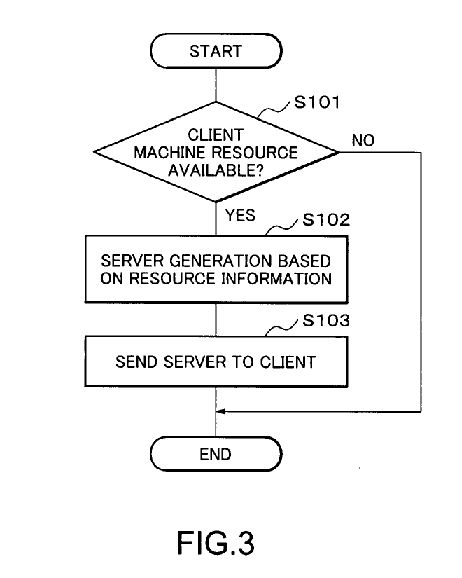

FIG. 3 shows the processes of the present invention.

(1) Step S101

The server manager 220 determines whether or not the resources of the client machine 100 are enough to run the server 222 based on the resource information 113 obtained from the client manager 112. This is because the operation of the server 222 requires sufficient machine resources. The server generator 221 determines the number of and the types of functions to be included in the server 222 according to the available resources of the client machine 100. The server 222 may also include all the necessary functions beforehand. In such a case, the server generator 221 eliminates high load functions and less important functions according to the available resources of the client machine 100.

(2) Step S102

If it is determined in the above step S101 that the client machine 100 has available machine resources for a sever 222, the server generator 221 creates a server 222 to be activated in the client machine 100 based on the resource information 113 and the requirement of the client 121.

(3) Step S103

The server manager 220 sends the server 222 and the information on resource required by the server 222 to the client manager 112.

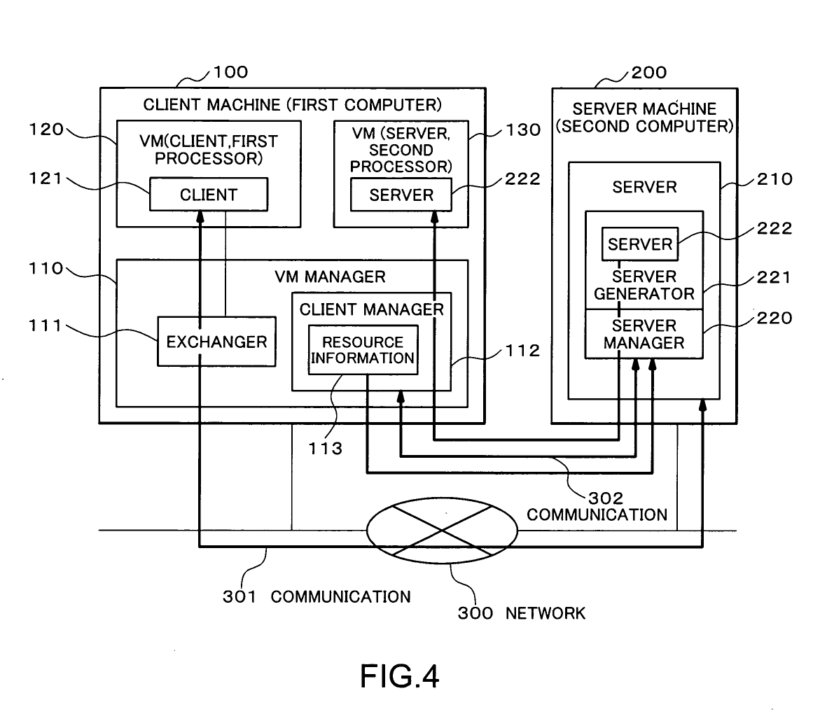

As shown in FIG. 4, the client manager 112 activates the virtual machine (VM) 130 to execute the server 222 received from the server manager 220. During this time, the client 121 keeps receiving the service from the server 210.

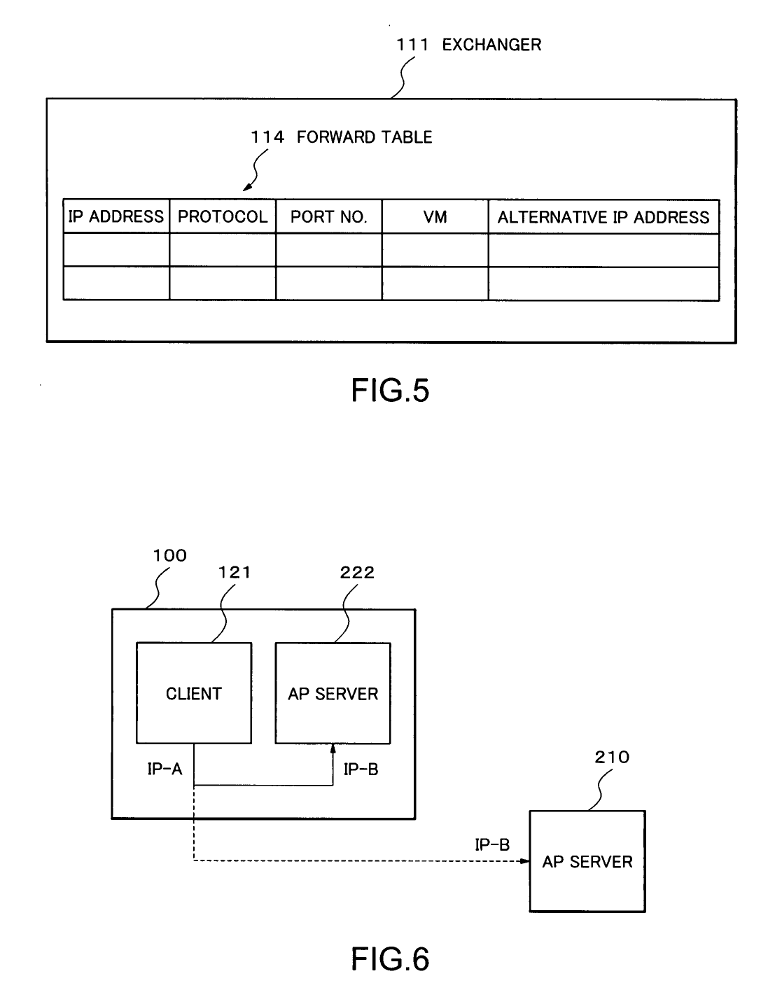

The client manager 112 registers an IP address, a protocol, and a port number of the server 210, as well as an identifier of the virtual machine (VM) 130 in a forward table 114 held by the exchanger 111 at a point of time (referred to as a synchronization point). FIG. 5 shows an example of the forward table 114.

The synchronization point depends on the content of each service supplied from the server machine 200 to the client machine 100. For a stateless service, the client manager 112 determines such a synchronization point freely. For example, the client manager 112 may chose a point of time when the VM 130 is activated as a synchronization point. For a stateful service, the server manager 220 notifies the client manager 112 of completion of each session. Receiving such notification, the client manager 112 determines a synchronization point. For a stateless service, a request does not depend on any past information; each request is independent. On the other hand, for a stateful service, a request might depend on past information. The attribute information 224 of the server 222 includes information for identifying that the subject service is a stateless or stateful one.

Based on the content registered by the client manager 112 in the forward table 114 at a synchronization point, the exchanger 111 determines the subsequent communication flow. The exchanger 111 changes the destination of the communication of client 121 in the virtual machine (VM) 120 from the server 210 to the server 222 in the virtual machine (VM) 130. The client 121 uses the server 210 before the synchronization point and uses the server 222 that runs in the virtual machine (VM) 130 after the synchronization point. This switching gives no effect on the client 121. The switching to be made while the client 121 is not sensible of it is referred to as transparent switching or seamless switching.

As shown in FIG. 6, the server 222 functions as an AP (application) server. Receiving a request from the client 121, the server 222 usually processes the request in place of the server 210 and returns a response to the client 121. At this time, the server 222 communicates only with the client 121, not communicate with any others. Here, the client 121 uses an IP address (IP-A) and the server 210 uses another IP address (IP-B).

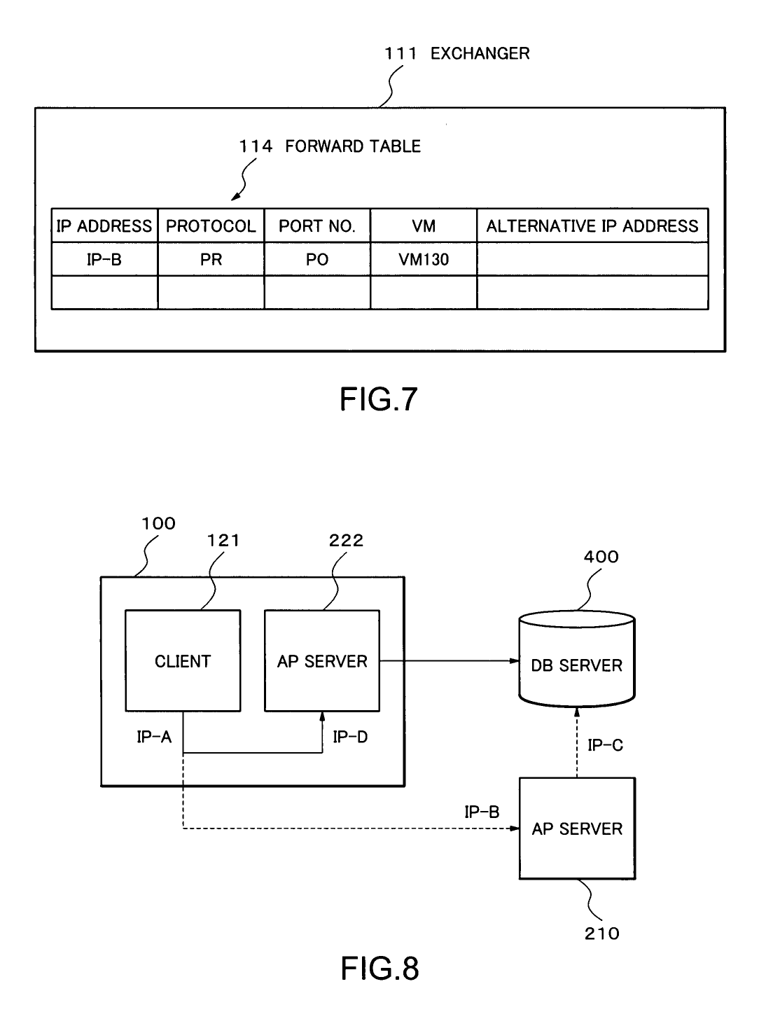

As described above, when the server 222 communicates only with the client 121, the forward table 114 includes the IP address (IP-B), protocol (Pr), port number (Po), and VM 130 of the server 210 as shown in FIG. 7. The VM 130 is an identifier of the virtual machine (VM) 130 in which the server 222 is running. The identifier of the virtual machine (VM) 130 is used by the exchanger 111 to identify the object VM at the time of communication. The server 222 uses the same IP address (IP-B) as that of the server 210. The IP address (IP-B) of the server 222 is effective only in the client machine 100; it is not used for communications with external. On this condition, there is no need to set any alternative address and accordingly no IP address rewriting is required.

FIG. 8 shows a variation of this first embodiment. In this variation, the sever 222 belonging to the VM 130 accesses an external DB server 400 in place of the server 210 to process the request received from the client 121. This DB server 400 is connected to the client machine 100 and the server 210 respectively. The server 210 and the DB server 400 may operate in the same server machine 200. In this variation, the client 121 uses an IP address (IP-A), the server 210 uses another IP address (IP-B), and the DB server 400 uses still another IP address (IP-C).

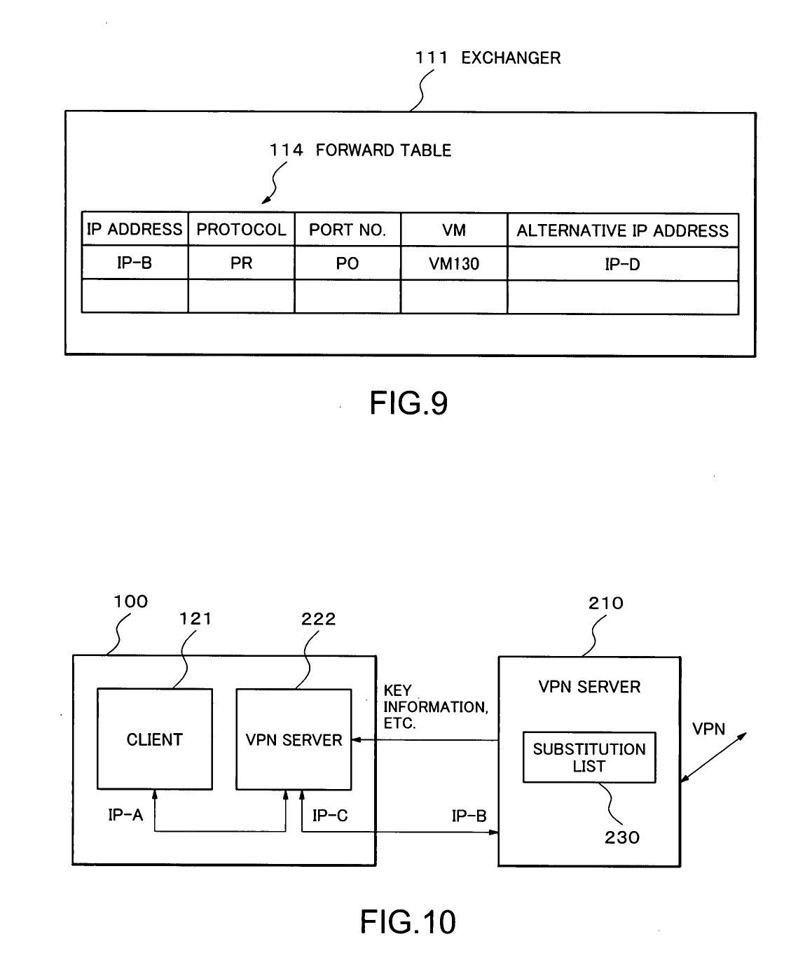

As shown in FIG. 9, the forward table 114 includes the IP address (IP-B), protocol (Pr), port number (Po) of the server 210, as well as the identifier of the VM 130. The server 222 uses an IP address (IP-D) that is different from that of the server 210. This IP address (IP-D) becomes an alternative IP address.

The communication from the IP address (IP-A) of the client 121, that is, the VM 120 to the IP address (IP-B), protocol (Pr), port number (Po) is switched to the communication from the IP address (IP-A) to the IP address (IP-D), protocol (Pr), and port number (Po).

To make this switching, the client manager 112 rewrites the IP address registered in the forward table 114. The communication from the IP address (IP-D) to the IP address (IP-A) is reported to the client 121 as the communication from the IP address (IP-B) to the IP address (IP-A). If the server 222 communicates with external (DB server 400 in this example), not with the client 121, the IP-D address is used as is.

In the second variation shown in FIG. 10, the server 210 is a VPN server. The VPN (Virtual Private Network) means a private communication network provided virtually using a wide range network owned by a communication provider. The VPN is provided, for example, using the IP sec protocol to an IP network provided by a communication provider.

The server 222 belonging to the VM 130 encrypts and decrypts packets in place of the server 210 (VPN server in this variation). A substitution list 230 held by the server 210 is a list of VPN servers (servers 222) whose functions are performed by the VM 130. If a packet source or destination is included in this substitution list 230, the server 222 encrypts and decrypts packets. In this case, the server 210 is not required to make encryption and decryption. The server 222 receives the necessary key information, etc. from the original server 210 (VPN server). The resource information 113 is sent from the server 210 (VPN server) to the client manager 112 when the first packet sent from or addressed to the client 121 is processed. The client 121 uses an IP address (IP-A) and the server 210 uses an IP address (IP-B).

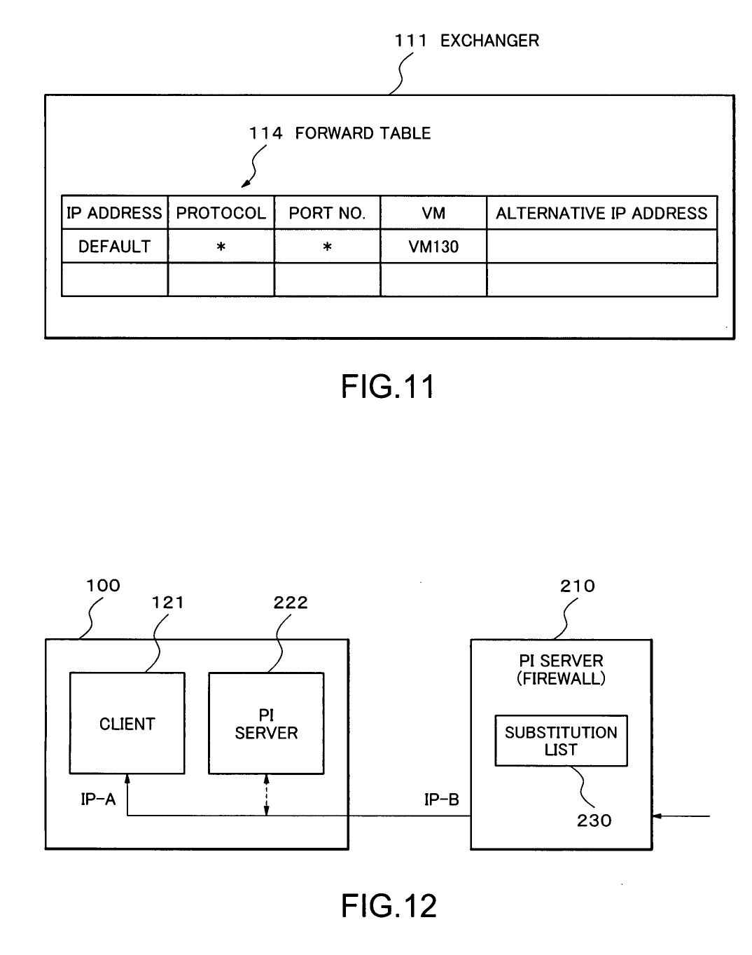

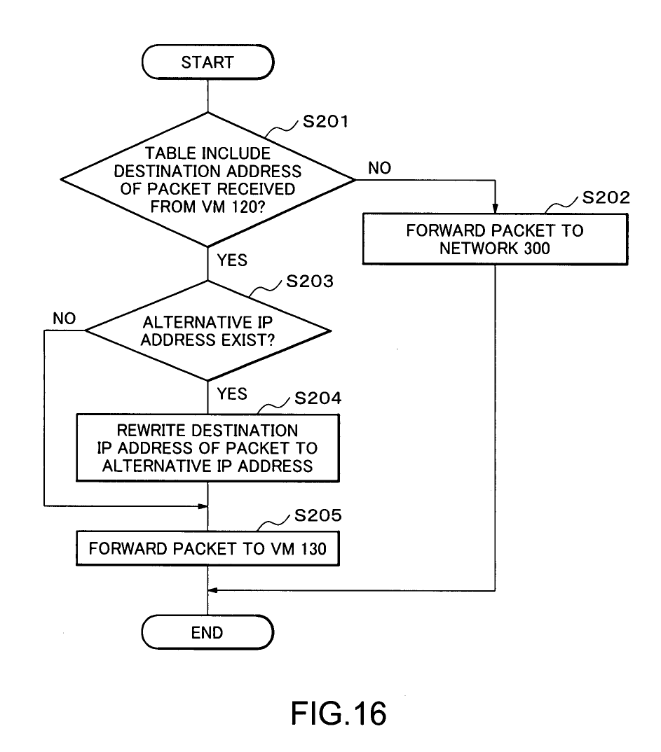

As shown in FIG. 11, the forward table 114 includes an address of a network or a host address that uses a VPN as an IP address. When making communications with all the network addresses or host addresses through a VPN, the forward table 114 includes specified default values. This means that the communication between the client 121, that is, the VM 120 and every destination address is subject to switching by the exchanger 111. In the flowchart shown in FIG. 16 to be described later, any destination address of packets is deemed to be registered in the forward table 114 (YES in S201).

The server 222 uses an IP address (IP-C) that is different from that of the server 210. This address is not used as an alternative IP address. This is because the destination address of packets sent from the client 121 is not the address of the VPN server (server 210).

In the third variation, as shown in FIG. 12, the server 210 is a PI (Packet Inspection) server. Packet inspection is a function used to read packet data, determine its content, then pass, discard, record, or notify the packet data to the manager for security reasons, etc.

The server 222 belonging to the VM 130 executes an inspection for each packet addressed to the client 121 in place of the PI server (server 210). At this time, the substitution list 230 held by the server 210 is assumed to be a list of clients 121 having a PI server (server 222) executed by VM 130. If the destination client 121 of the received packet is included in this list 230, the server 210 does not make inspection. The exchanger 111 passes packets to the client 121 via the PI server (server 222) and the server 222 makes inspection in stead of the server 210.

The server 210 (PI server) requests resource information 113 to the client manager 112, when the first packet sent from or addressed to the client 121 is processed by server 210.

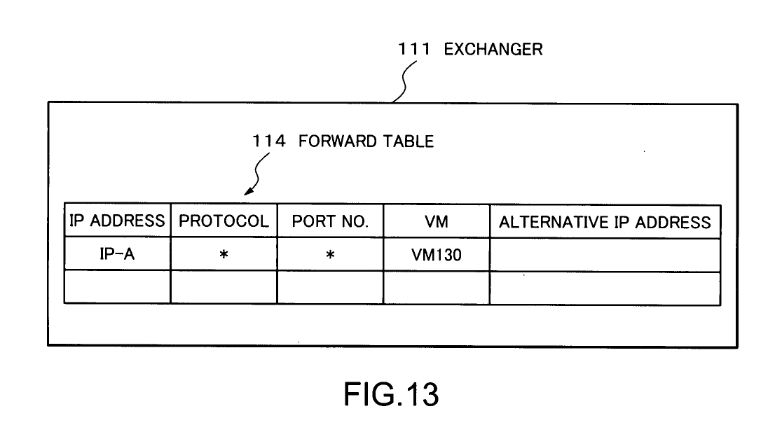

As shown in FIG. 13, the forward table 114 includes the IP address (IP-A). This is because a communication packet to the IP address (IP-A) of the client 121 is to be processed by the exchanger 111. The server 222 does not require any IP address to make packet inspection. This is because the server 222 does not send/receive any packets. The server 222 also requires no alternative IP address for the server 210 (PI server) in a firewall or the like. This is because packets are not originated from a server 210 (PI server). Consequently, the forward table 114 does not include those addresses.

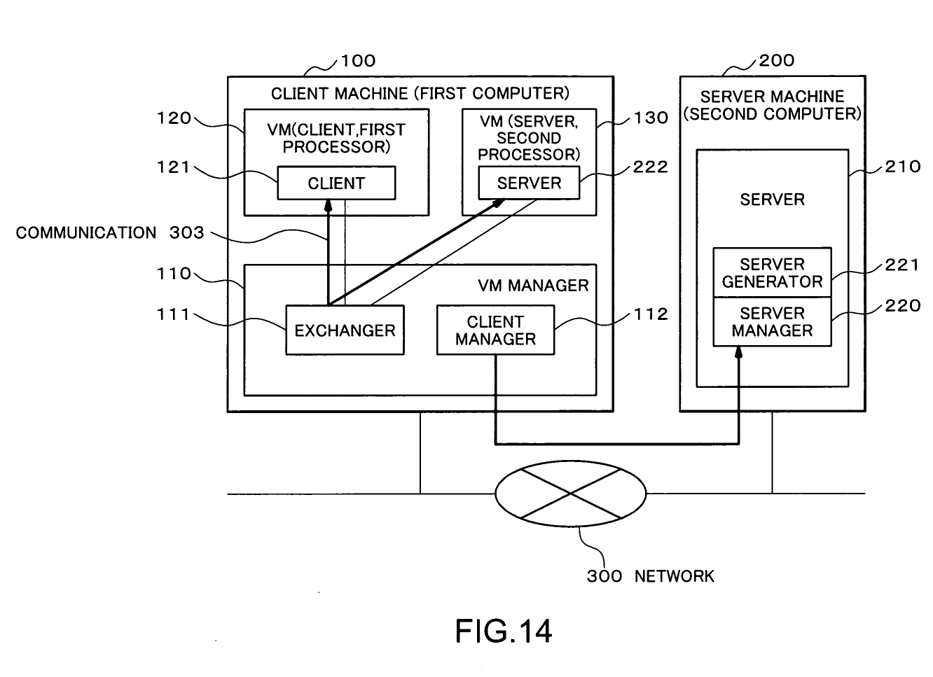

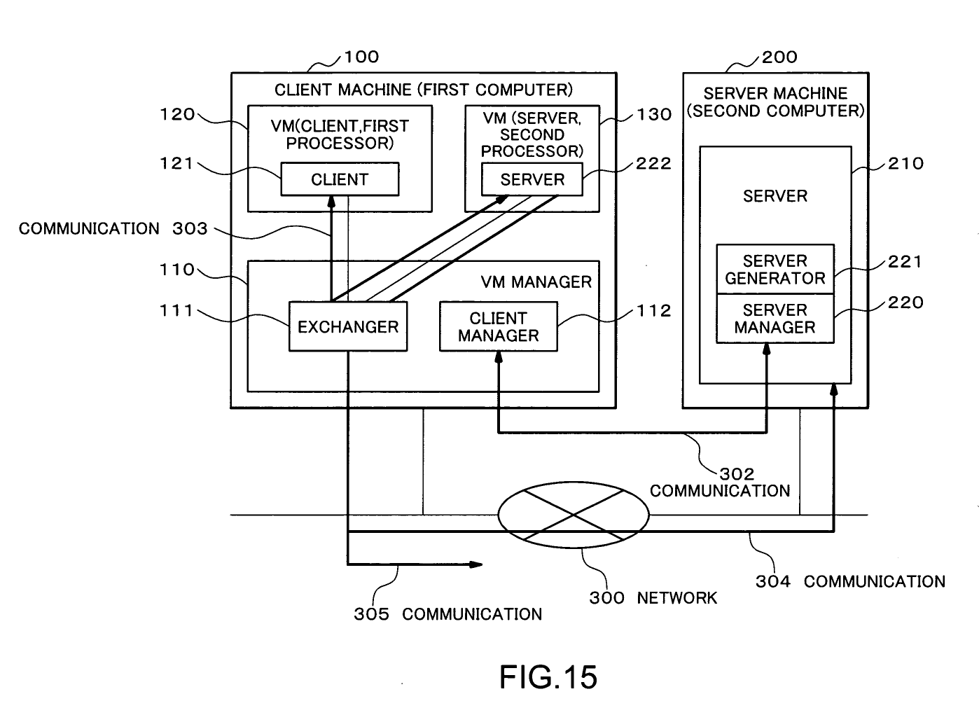

FIGS. 14 and 15 show communications to be made after data is registered in the forward table 114.

The exchanger 111 transfers packets which are sent from the client 121 and addressed to the server 210, to the server 222. FIG. 14 shows a case in which the server 222 communications only with the client 121. The server 222, that is, the VM 130 has the same IP address of that of the server 210. FIG. 15 shows a case in which the server 222 communicates not only with the client 121, but also with others. FIG. 15 shows a case in which not only the communication 302, but also the communications 304 and 305 are made. In the case shown in FIG. 15, the server 222, that is, the VM 130 and the server 210 have different IP addresses respectively. The forward table 114 of the exchanger 111 shown in FIG. 15 includes the IP address of the server 222, that is, the VM 130 as an alternative IP address. The alternative IP address is used to distinguish between server machine 200 (server 210) and the VM 130 (server 222).

FIG. 16 shows a flowchart of processes by the exchanger 111 for the packets received from the VM 120 (client 121) shown in FIGS. 14 and 15 respectively with use of the forward table 114.

(1) Step S201

The exchanger 111 checks whether or not the destination IP address of a packet received from the VM 120 (client 121) is registered in the forward table 114. If the default value is registered in the forward table 114 as in FIG. 11, the exchanger 111 determines that all the destination addresses are registered in the table 114.

(2) Step S202

If the destination IP address of the packet is not registered in the forward table 114, the exchanger 111 transfers the packet to the network 300.

(3) Step S203

If the destination IP address is registered in the table 114, the exchanger 111 checks whether or not an alternative IP address corresponding to the destination IP address is registered in the table 114.

(4) Step S204

If the alternative IP address is registered in the table 114, the exchanger 111 rewrites the destination IP address of the packet to the alternative IP address.

(5) Step S205

The exchanger 111 transfers the packet received from the VM 120 (client 121) to the VM 130 (server 222) registered in the forward table 114.

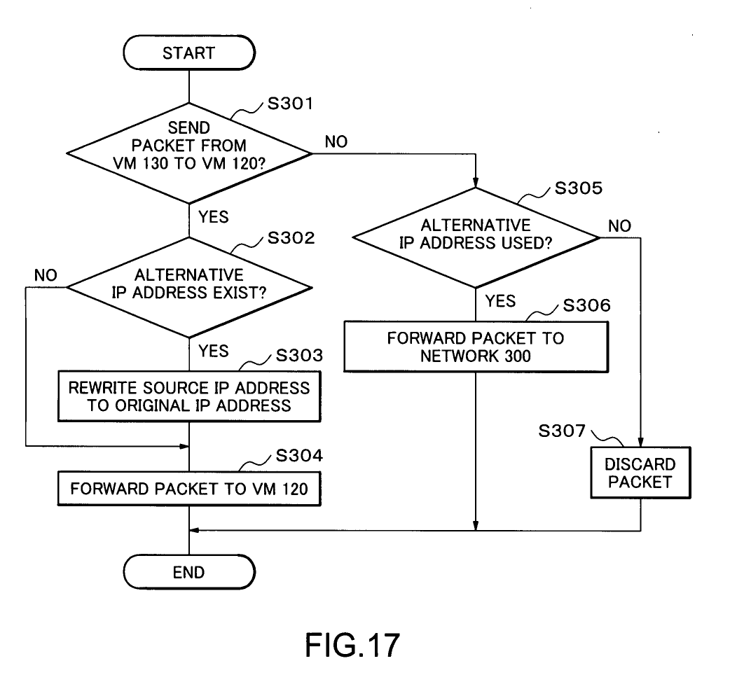

FIG. 17 shows a flowchart in which the exchanger 111 processes a packet received from the VM 130 (server 222) shown in FIGS. 14 and 15 respectively with use of the forward table 114.

(1) Step S301

The exchanger 111 checks whether or not the packet received from the VM 130 (server 222) is addressed to the VM 120 (client 121).

(2) Step S302

If the packet is addressed to the VM 120 (client 121), the exchanger 111 checks whether or not an alternative IP address is used.

(3) Step S303

If an alternative IP address is used, the exchanger 111 obtains an entry of which the protocol (Pr), the port number (Po) and the VM information are matching with those of the packet or the parameter given from client 121 from the forward table 114. The exchanger 111 then rewrites the alternative IP address to the IP address of the entry, which is the IP address of the server 210.

(4) Step S304

The exchanger 111 transfers the address-rewritten packet to the VM 120 (client 121).

(5) Step S305

If the packet received from the VM 130 (server 222) is not addressed to the VM 120 (client 121), the exchanger 111 checks whether or not an alternative IP address is used.

(6) Step S306

If an alternative IP address is used, the exchanger 111 transfers the packet to the network 300.

(7) Step S307

If any alternative IP address is not used, the exchanger discards the packet.

In the third variation shown in FIG. 12, the exchanger 111, upon receiving a communication packet from the server 210, checks whether or not the address is registered in the forward table 114. If it is registered, the exchanger 111 outputs the packet to the VM 130 registered in the forward table 114. In the VM 130, the server 222 inspects the packet. If the address is not registered, the exchanger 111 outputs the packet to the communication entity having the packet destination address (ordinary communication).

The exchanger 111 outputs a packet received from the VM 130 to the VM 120.

In this embodiment, the load of the server 210 to which accesses are concentrated can be reduced with use of the client machine 100. This is because the client machine 100 executes the server 222. In addition, even when the client machine 100 executes the server 222, the security is assured, since the client 121 and the server 222 are executed in the VM 120 and 130 respectively.

Next, a second embodiment of the present invention will be described.

In this second embodiment, the user initiates the download of the server 222 to the client machine 100 to operate the server 222.

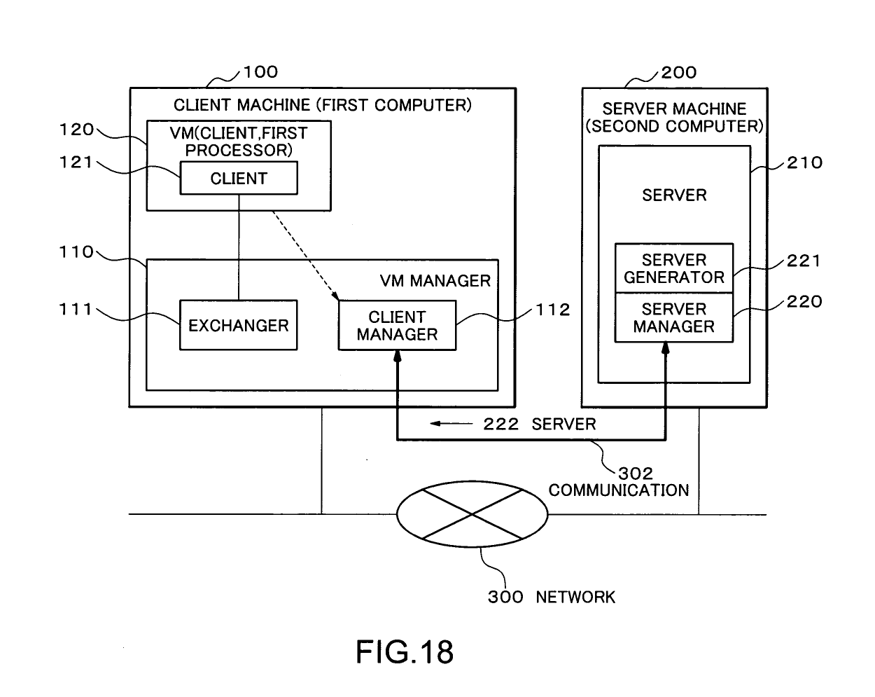

In FIG. 18, the user requests the client manager 112 to download the server 222 through the VM 120: The request is issued, for example, by executing a predetermined operation for a predetermined device, by pressing a predetermined button provided at the client machine 100, or by executing an operation on a Web page/application screen displayed at the client machine 100. For example, when the user feels that the load of the server machine 200 is excessive, the user executes one of the above operations to instruct the client manager 112 to download the server 222. Receiving the instruction, the client manager 112 supplies resource information 113 of the client machine 100 to the server manager 220. Receiving the resource information 113, the server generator 221 generates a server 222 and supplies the generated server 222 to the client machine 100. Unlike the first embodiment, in this second embodiment, the client manager 112 connects the server manager 220 to start the communication 302. Hereinafter, the server 222 is transferred to the client machine 100 similarly to the procedure in the first embodiment.

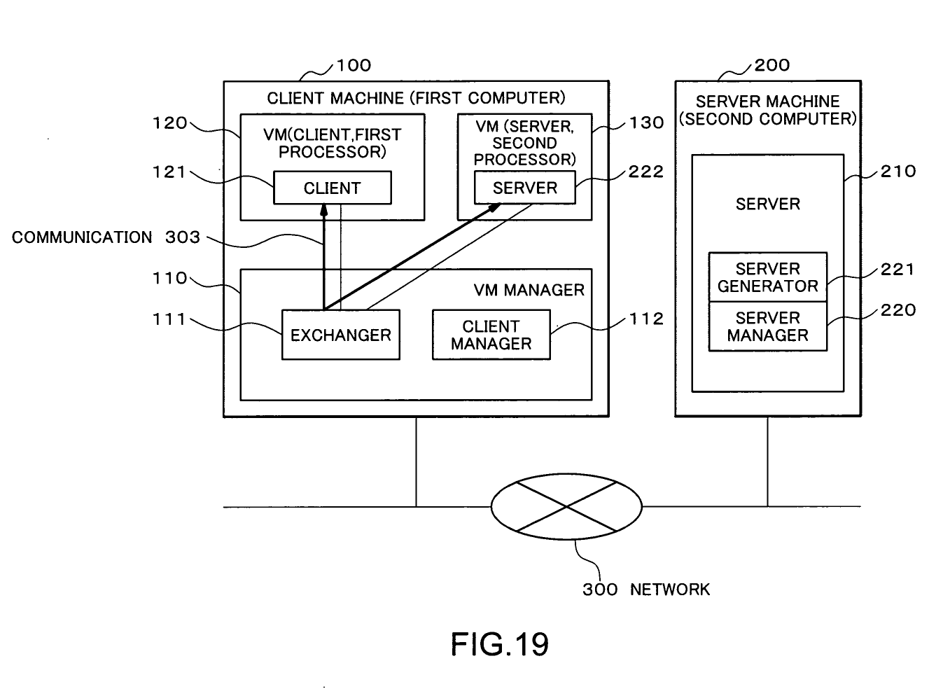

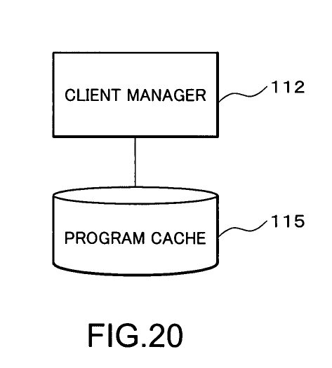

FIG. 19 shows the client machine 100 in an off-line state in which the machine 100 is disconnected from the network 300. In this second embodiment, the client 121 can use the server 222 even in the off-line state. And in this second embodiment, as shown in FIG. 20, the client manager 112 may have a program cache 115 on the disk and the program cache 115 may store the program of the server 222 for a certain period. In this case, there is no need to download the server 222.

In this second embodiment, the user can adjust the load of a target server (server 210) properly, since the user can request downloading of the server 222.

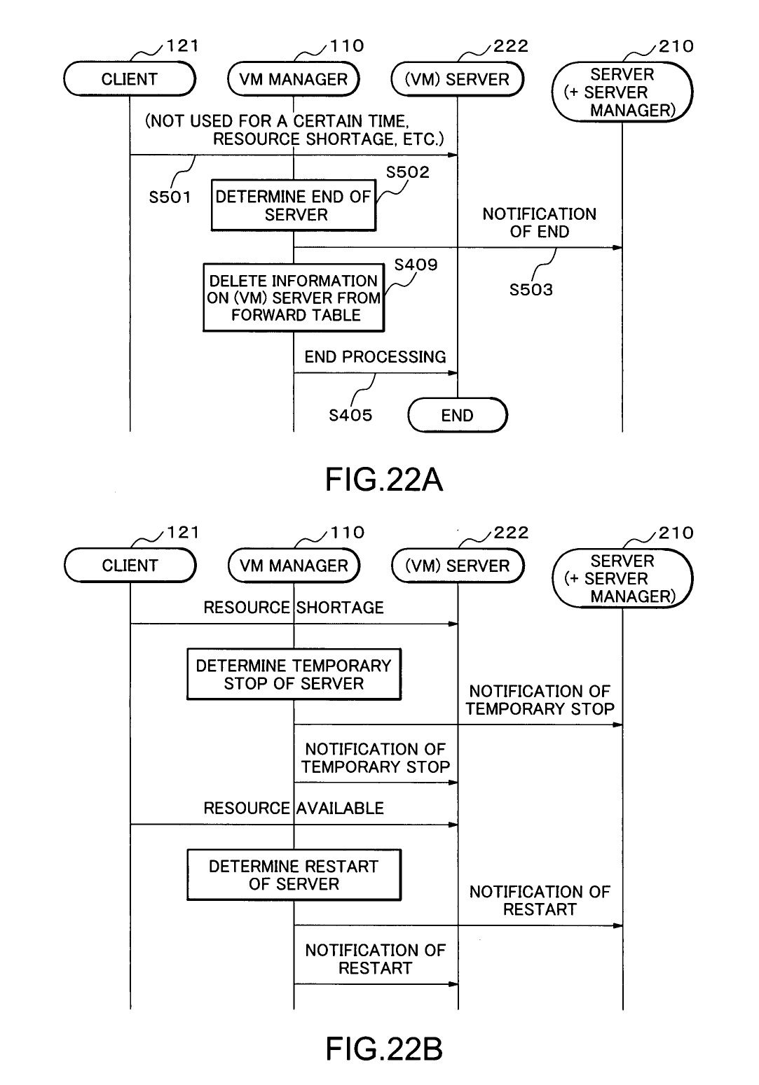

FIG. 22A shows a third embodiment of the present invention. In this third embodiment, the client manager. 112 in a system in FIG. 14 or 15 stops the VM 130 if the load of the client machine 100 goes over a predetermined reference value to avoid overload. When the VM 130 stops, the client 121 uses the server 210 again. To stop the VM 130, the client manager 112 deletes the registered information of the VM 130 from the forward table 114.

In this third embodiment, the system can correspond to an increase of the load of the client 100 flexibly. If the load rises excessively, the server 222 execution is stopped.

FIG. 22B shows a fourth embodiment of the present invention. In this fourth embodiment, the client manager 112 in a system in FIG. 14 or 15 instructs the client 121 to stop the use of the server 222 temporarily if the load of the server 222 goes over a first predetermined reference value and the resource is insufficient. The client manager 112 then enables the client 121 to use the server 210.

When the load falls under s second predetermined reference value and the resource becomes available for the sever 222, the client manager 112 enables the client 121 to restart the use of the server 222. The client manager 112 may also stop the server 222 not only when the resource is insufficient, but also when the performance of the client machine 100 falls.

The client manager 112 can also enable the client 121 to use both the server 210 and the server 222 in parallel without stopping the server 222. In this case, processes are distributed to the server 210 and to the server 222 according to, for example, the load of each of the server 210 and the server 222, as well as according to the machine resource of each of the server 210 and the server 222.

In this fourth embodiment, the system can correspond to the load variation of the client 100 flexibly. This is because the execution of the server 222 can be temporally stopped and restarted according to an increase/decrease of the load.

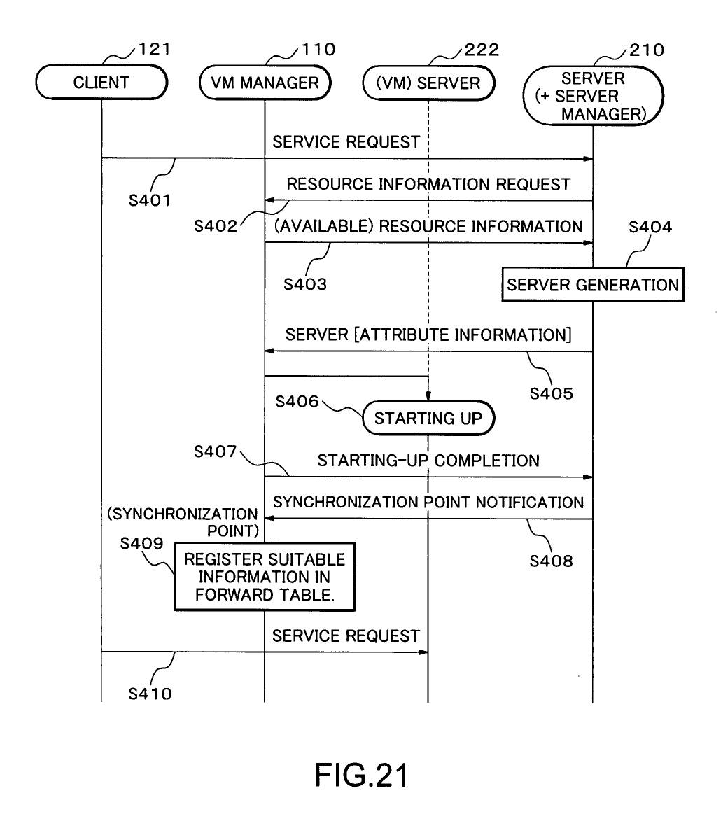

FIG. 21 shows the whole operation of the system in the embodiment described above.

(1) Step S401

The client 121 accesses the server 210. For example, the client 121 requests a service from the server 210.

(2) Step S402

The server manager 220 of the server 210, receiving a service request from the client 121, requests the resource information 113 from the VM manager 110. The VM manager 110 may be executed in a computer other than the client 121. For example, the VM manager 110 may be executed in a relay unit provided between the client machine 100 and the server machine 200.

(3) Step S403

The VM manager 110 supplies the resource information 113 to the server manager 220 of the server 210. The information 113 denotes machine resources available in the client machine 100.

(4) Step S404

The server generator 221 in, the server 210 refers to the resource information 113 supplied from the VM manager 110 to determine whether to generate a server 222. If the resources are sufficient, the server generator 221 generates the server 222 for the VM manager 110 based on the resource information 113. If the resources are insufficient, the server generator 221 ends the processing without generating the server 222.

(5) Step S405

The server 210 supplies the server 222 and its attribute information 224 to the VM manager 110.

(6) Step S406

The VM manager 110 activates the server 222 in the VM 130 belonging to the client machine 100.

(7) Step S407

The VM manager 110 notifies the server manager 220 in the server 210 of completion of the activation of the server 222.

(8) Step S408

For a tasteful service, the server manager 220 of the server 210 notifies the VM manager 110 of a synchronization point.

(9) Step S409

The VM manager 110 registers information for a communication switching at the synchronization point in the forward table 114. When the system supplies a stateful service, this processing is executed upon receiving notification from the server manager 220. When the system supplies a stateless service, the processing may be executed upon receiving notification from the server manager 220 or the VM manager 110 may determine a proper timing for the processing.

(10) Step S410

The client 121 requests a service from the server 222. In other words, the client 121 accesses the server 222 in place of the server 210.

FIG. 22A shows a case in which the server 222 is not used for a certain time in the above embodiment.

(1) Step S501

The VM manager 110 monitors the communication of the client 121 and if the client 121 does not use the service supplied from the server 222 for a certain time, the VM manager 110 detects the state. In other words, the VM manager 110 detects a state in which the communication between the client 121 and the server 222 is kept idle for a certain time due to a trouble, for example, occurred in the server 222 because of insufficient resources in the client 121.

(2) Step S502

The VM manager 110 determines the end of the server 222.

(3) Step S503

The VM manager 110 notifies the server manager 220 of the server 210 of the end of the server 222. Before stopping the server 222, the VM manager 110 synchronizes the server 210 and the server 222 each other as needed.

(4) Step S504

The VM manager 110 deletes the information of the VM 130 from the forward table 114 at the synchronization point. The VM 130 is executing the server 222.

(5) Step S505

The VM Manager 110 ends the server 222.

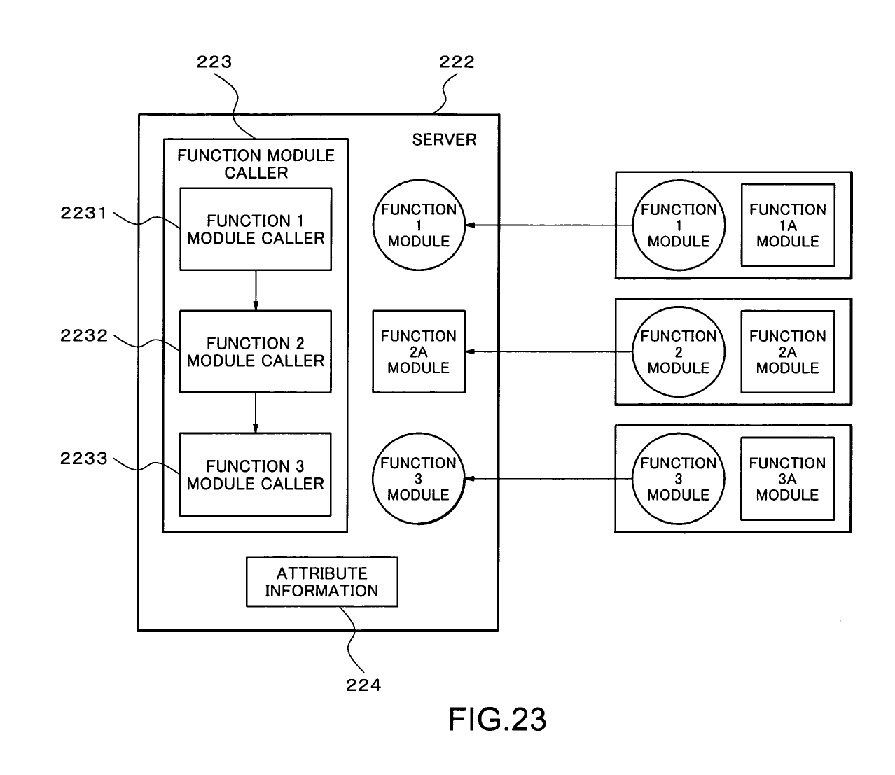

FIG. 23 shows an example for generating the server 222.

For example, if the functions 1 to 3 are required for the server 222, the server 210 includes the function modules 1A to 3A, as well as the function modules 1 to 3. The function modules 1A to 3A are used to call the function modules 1 to 3 remotely. The server generator 221 incorporates for example function 1 module, function 2A module and function 3 module to the server 222. The server generator 221 also generates the function module caller 223 for recording the sequence and condition for calling those function modules. The sequence and condition for calling those function modules may be included in the attribute information 224.

The function module caller 223 includes a function 1 module caller 2231, a function 2 module caller 2232, and a function 3 module caller 2233. The function 1 module caller 2231 calls the function 1 module or the function 1A module incorporated in the server 222. The function 2 module caller 2232 calls the function 2 module or function 2A module incorporated in the server 222. And the function 3 module caller 2233 calls the function 3 module or the function 3A module incorporated in the server 222.

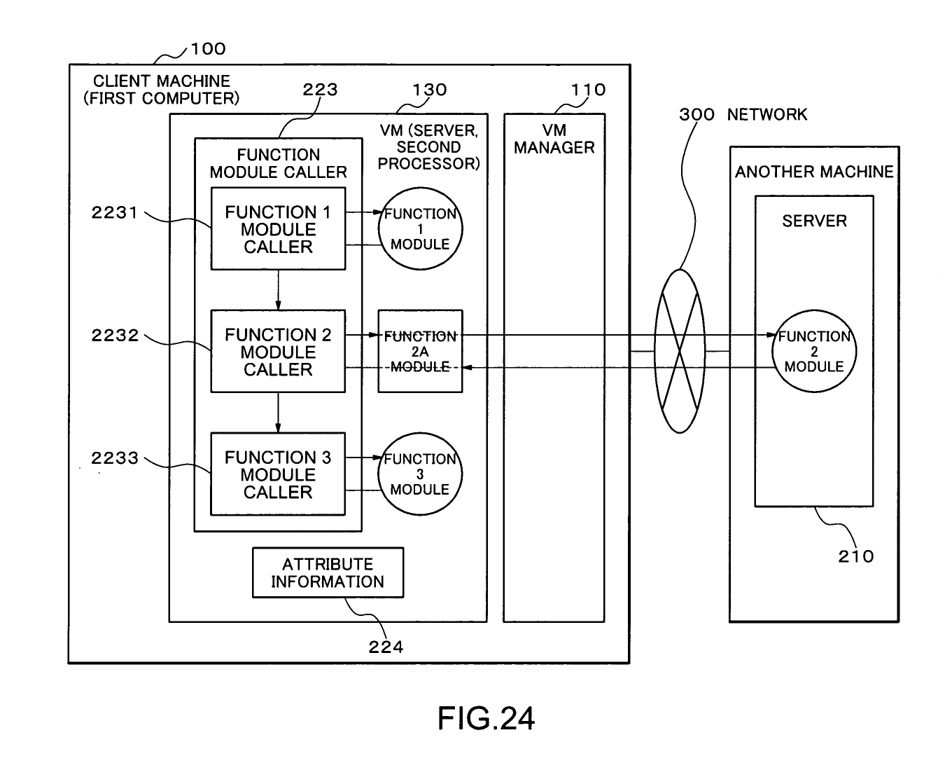

The server 222 generated by the server generator 221 runs in the VM 130. The function module caller 223 calls the function 1 or 1A module to the function 3 or 3A module sequentially. The function 2A module called by the function module caller 2232 requests the server 210 that operates in the server machine 200 to execute the function 2 module as shown in FIG. 24. When the server 210 notifies this execution result to the function 2A module, the function 2A module returns the result to the function 2 caller 2232.

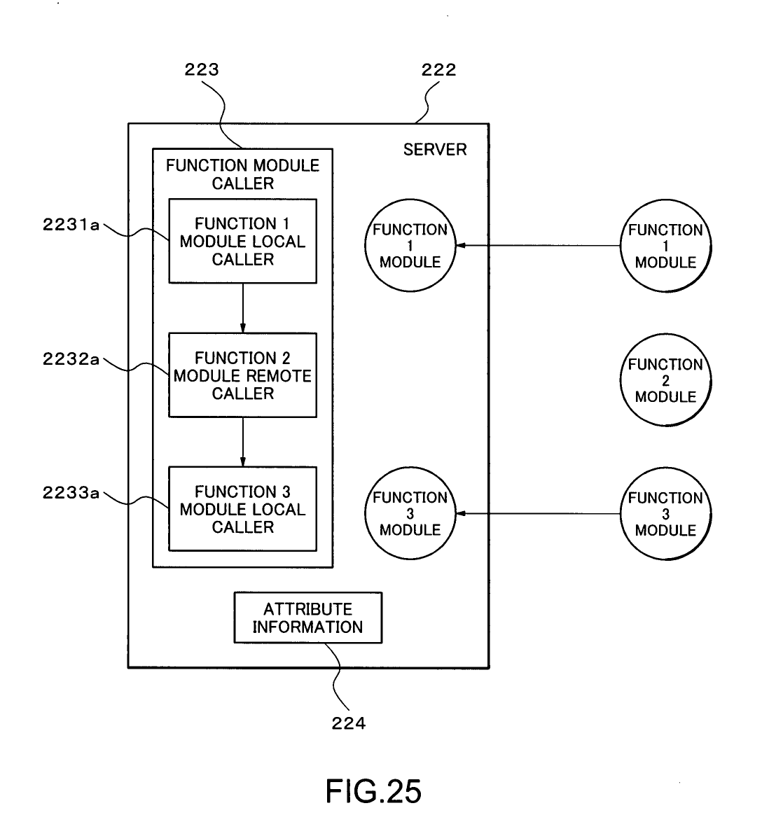

FIG. 25 shows an example for generating another server 222 different from that shown in FIG. 23.

The server 210 shown in FIG. 25 does not include the function modules 1A to 3A. If the functions 1 to 3 are required to execute the functions of the server 210, the server generator 221 incorporates only the function 1 module and function 2 module in the server 222. Unlike the case shown in FIG. 23, the server generator 221 cannot incorporate the function 2A module in the server 222. The server generator 221, when generating the function module caller 223, creates a local caller with respect to the incorporated function modules (for example function 1 module and function 2 module) and a remote caller with respect to the not-incorporated function modules (for example function 2 module). The details of the operation are similar to that shown in FIG. 23.

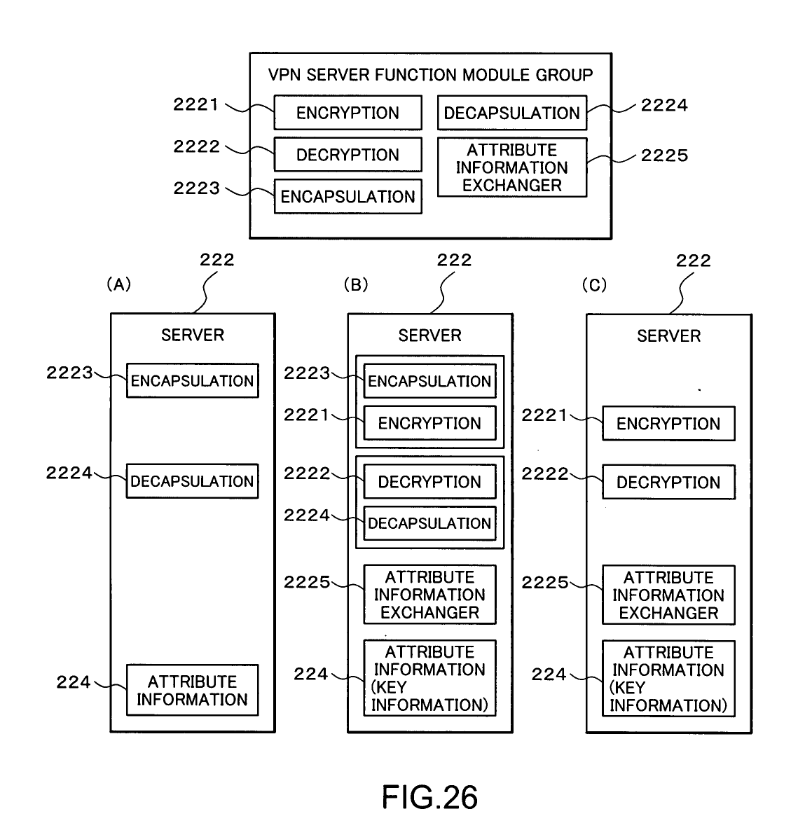

FIG. 26 shows an example for generating a VPN server.

There are the following three types of VPN technology.
(a) Tunneling only
(b) Tunneling+encryption
(c) Encryption of data only

As shown in FIG. 26, the function module group of the VPN server includes an encryption unit 2221, a decryption unit 2222, an encapsulation unit 2223, a decapsulation unit 2224, an attribute information exchanger 2225.

The encryption unit 2221 encrypts data. The decryption unit 2222 decrypts encrypted data. The encapsulation unit 2223 encapsulates packets. The decapsulation unit 2224 decapsulates encapsulated packet data. The attribute information exchanger 2225 exchanges key information used for encryption and decryption between VPN servers.

In the case of (a), the server 222 includes an encapsulation unit 2223, a decapsulation unit 2224, and attribute information 224. In the case of (b), the server 222 includes an encryption unit 2221, a decryption unit 2222, an encapsulation unit 2223, a decapsulation unit 2224, an attribute information exchanger 2225, and attribute information 224. The attribute information 224 includes key information. The VPN server with tunneling capability may have a plurality of addresses and may use different addresses for different clients. In the case of (c), the server 222 includes an encryption unit 2221, a decryption unit 2222, an attribute information exchanger 2225, and attribute information 224. The attribute information 224 includes key information.

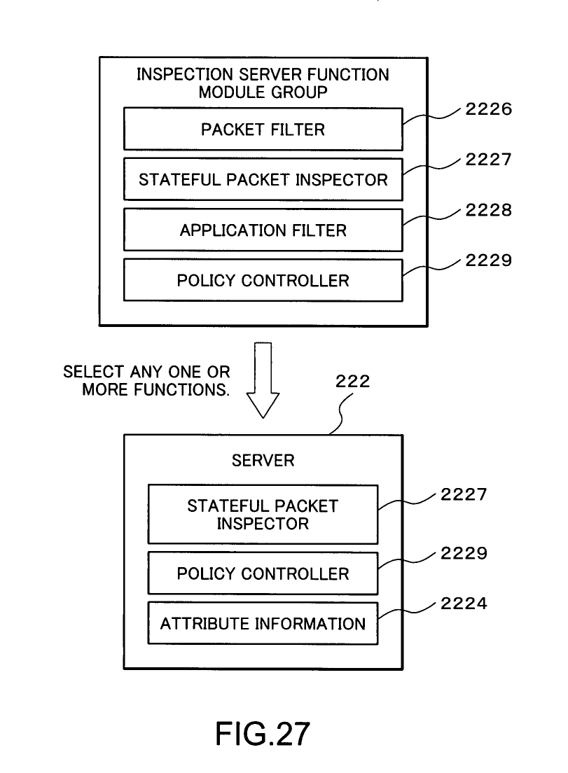

FIG. 27 shows an example for generating a PI server.

The function module group of the packet inspection server includes a packet filter 2226, a stateful packet inspector 2227, an application filter 2228, and a policy controller 2229. The packet filter 2226 checks parts of a packet (ex., header) to determine whether to transfer or reject the packet. The stateful packet inspector 2227 reads the data of a packet and open or close the port dynamically based on the contents of the packet. The application filter 2228 sets rules for determining whether to permit or reject the communication for each application. The policy controller 2229 manages and controls the policy of the network system.

The server generator 221 selects at least one of those functions to generate a server 222. For example, the server 222 includes the tasteful inspector 2227, the policy controller 2229, and the attribute information 224.

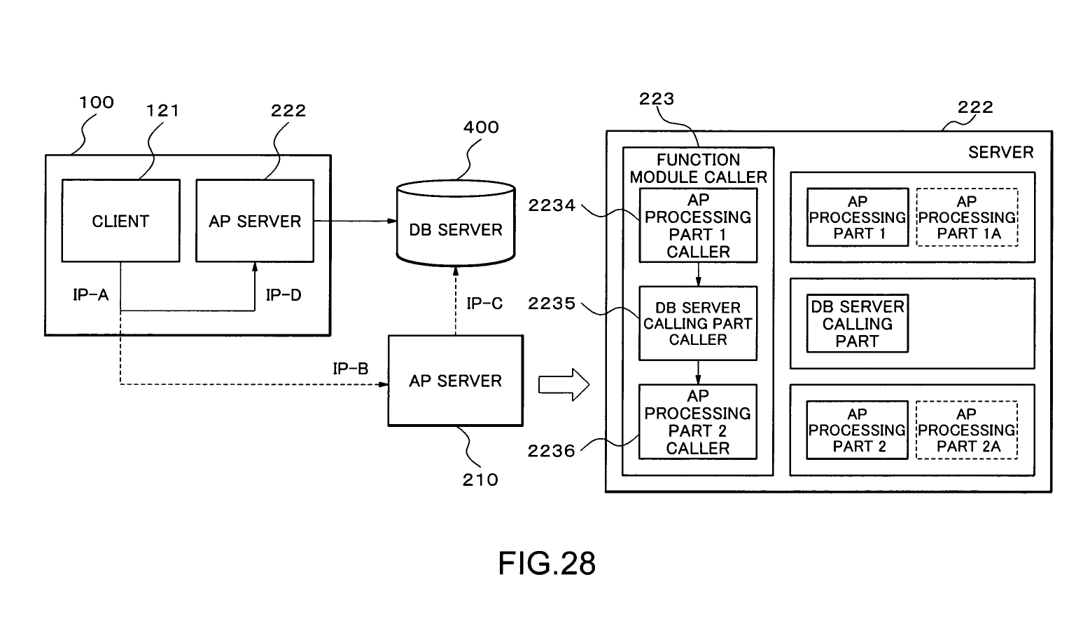

FIG. 28 shows an example for generating an AP server.

The AP server function module group includes a function module caller 223. The function module caller 223 includes an AP processing part 1 caller 2234, a DB server calling part 2235, and an AP processing part 2 caller 2236. The AP processing part 1 caller 2234 calls and executes the AP processing part 1 or 1A. The AP processing part 1 is equivalent to the function 1 module shown in FIG. 23. The DB server calling part 2235 calls and executes the DB (database) server caller. The DB server calling part accesses the DB server 400. And the DB server calling part is equivalent to the function 2 module shown in FIG. 23. The AP processing part 2 caller 2236 calls and executes the AP processing part 2 or 2A. The AP processing part 2 is equivalent to the function 2 module shown in FIG. 23.

The server generator 221 selects necessary function modules from the AP server function module group to generate a server 222 used as an AP server. The AP server processing flow will be as follows; AP processing part 1→DB server calling part→AP processing part 2. In a generation of a server 222, the function module caller 223 specifies a calling sequence of processes so that those processes are called sequentially. The server generator 221 selects whether to execute each of those processes locally or remotely to generate necessary function modules. In the case of a local processing, each function module incorporated in the server 222 is executed. In the case of a remote processing, each function module in the server 210 is called remotely and executed.

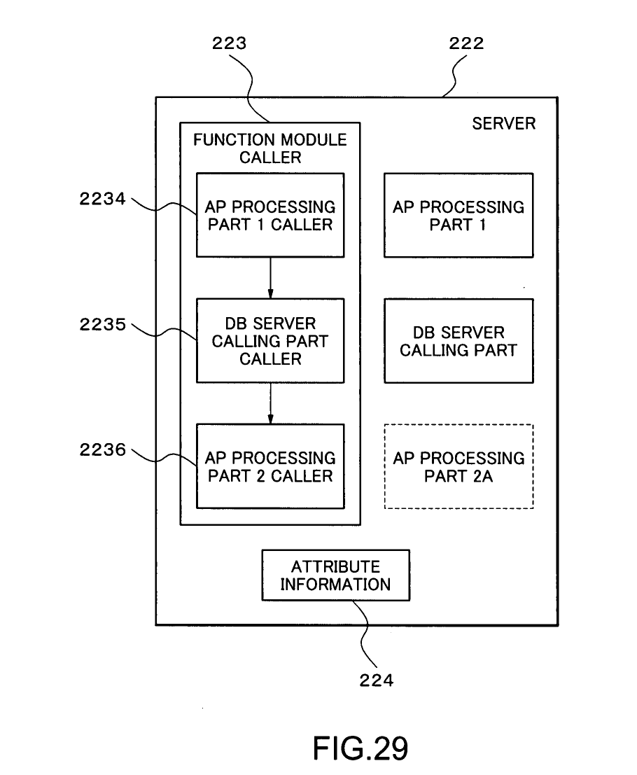

FIG. 29 shows an example in which the server 222 executes the AP processing part 1 locally, and then executes the AP processing part 2 remotely (in the AP server machine 200). The server 222 includes the function module caller 223, the AP processing part 1, the DB server calling part, and the AP processing part 2A.

The client machine 100 determines whether to select a local processing or a remote processing according to whether or not the client machine 100 has resources (memory, etc.) required for executing each necessary function module.

For example, a 128 MB memory size is required for executing the AP processing part 1 and a 512 MB memory size is required for executing the AP processing part 2. And those information items are given beforehand and stored as information belonging to the AP server function module group.

The server generator 221 obtains the resource information 113 of the client machine 100 from the client machine 100 and compares the information with those memory information items. If the available memory size of the client machine 100 is 256 MB, the AP processing part 1 can be executed in the client machine 100, but the AP processing part 2 cannot be executed in the client machine 100. Consequently, the server generator 221 generates the server 222 so that the server 222 can execute the AP processing part 1 locally and execute the AP processing part 2 remotely.

In the above example, the server generator 221 determines whether to select a local processing or a remote processing with respect to the execution of the AP processes 1 and 2 respectively according to the resource of the computer required by the function module. The server generator 221 may also make such determination according to the place where there are environmental items (OS, data, etc.) required to execute the function module. In this case, the server generator 221 makes a comparison between the following two choices to execute the function module; choice 1; moving the environmental items to the client machine 100 to execute the module and choice 2; execute the module in the server machine 200 that has those environmental items.

Finally, the outline of the present invention will be described.

The present invention relates to a client/server system.

A client machine 100 includes a VM 120 in which a client 121 runs, a VM 130 started up as needed to operate a server 222, and a VM manager 110 for managing the VMs 120 and 130.

The VM manager 110 includes the following items.
1. An exchanger 111 for managing the communications of the VMs 120 and 130
2. A forward table 114 held in the exchanger 111
3. A client manager 112, which is a management core of the client machine 100
4. Resource information 113 prepared for each VM and held by the client manager 112

The server machine 200 includes a server 210, a server manager 220, which is a management core of the server machine 200, and a server generator 221 for generating a server 222 to be sent to the client machine 100.

The client machine 100 is managed by a machine manager and connected to a network 300. The VM manager 110 described above is one of such machine managers. If the client 121 runs in the VM 120/130 in the client machine 100, the machine manager may be replaced by a VM monitor for monitoring the VM 120/130.

This machine manager can operate a second server 222 dedicated to the client 121 on a condition. A first server 210 for supplying a service operates in a server machine 200 that is different from the client machine 100. If the second server 222 operates in the VM 130 of the client machine 100, the machine manager generates the VM 130 that operates this second server 222.

Next, the operation of the present invention will be described briefly.
(1) The client machine 100 connects itself to the first server 210, that is, the server machine 200 (IP address A) to requests a service from the server. After the client machine 100 and the first server 210 are authenticated mutually, the machine manager opens a service port to connect itself to the server 210.
(2) The first server 210 makes an attempt to connect itself to a service port of the machine manager. If the connection to the service port fails, thereinafter, the first server 210 keeps supplying a service to the client 121.
(3) If the connection to the service port is successful, the first server 210 receives resource information 113 related to the available resources of the client machine 100 from the machine manager to confirm the existence of available resources. Then, the first server 210 sends a program of the server 222 for supplying the service and necessary environmental information items to the machine manager while supplying the service to the client 121.
(4) The machine manager stores the program and the environmental information items received from the server 210 in an area prepared for the VM 130 required to operate the server 222. Then, the machine manager gives an IP address A or B to the VM 130 and enables the VM 130 to start the operation. Thus the server 222 is executed in the VM 130. At this time, the second server 222 is not connected to the network 300 yet.
(5) The first server 210 uses the machine manager so as to be synchronized with the second server 222, and then notifies the machine manager of switching to the second server 222.
(6) Hereinafter, the machine manager forwards the communication from the client 121 to the first server 210 having the IP address A to the second server 222. The client 121 is not related to this forwarding, which is done transparently or seamlessly. In the case of the communication from the second server 222 to other than the client 121, the machine manager translates the IP address A of the first server 210 to the IP address B with use of its network address translating function.
(7) If the communication from the client 121 to the second server 222 stops for more than a certain time, the machine manager stops the second server 222 and releases the resources.

The system in other variations of this invention connects a computer having an application gateway to a LAN (Local Area Network) connected to the client machine 100 in place of the client 121. The computer makes switching between servers with use of a VM.

The VM often consists of a software program for operating the VM and a processor for reading and executing the software program. Consequently, the “VM” mentioned here can be regarded as a generic name of a combination of the software program and the processor.

In addition, the present invention enables the VM to be substituted for a real machine. For example, the VM 120/130 shown in FIG. 1 may be substituted for a processor, functional hardware, or the like.

If the client machine 100 consists of a group of terminal units connected to each another through such a network as a LAN, the VM 120/130 may be a terminal unit provided in the system. In other words, the client 121 and the server 222 may be executed in different terminal units respectively. In this case, the VM manager 110 functions as a monitoring unit for monitoring the communication of the terminal unit or a relaying unit.

In the above description, identification information (address information) used for communications is an IP address, but it is just an example; the present invention is not limited only to this example. The present invention can use other information that can identify the client and server uniquely in place of the IP address. For example, it is possible to use an ID or identification name in the network domain to which the client machine 100 and the server machine 200 belongs.

As described above, the feature of the present invention is operating not only the client 121, but also the server 222 dedicated to the client server 121. The client 121 and the server 222 communicate with each other through a virtual network, but the client 121 uses the server 222 while it uses the address of the server 210. Consequently, the client 121 does not distinguish between the server 210 and the server 222 as an opposite party with which it communicates. And because the server 222 is separated from the client 121 by the VM 120/130, the security degradation risk can be avoided even when the server program is executed in the client machine 100.

Finally, the present invention related technologies will be described below.

PC server performance has been improved year after year. And accordingly, there are signs of popularity now in solutions such as server integration and client integration that use VM (virtual machine) software programs respectively.

Servers in each of the systems that adopt those solutions process many data, so that the processing load is concentrated in servers in some systems.

On the other hand, while ordinary PC performance is improved sufficiently, client PC resources often to become excessive. And now the client machine 100 comes to take over some of processes now performed by servers.

A client server system consists of a server machine for supplying services and a client machine for requesting the services while those machines are connected to each other through a network. The server machine, upon receiving a service request from the client machine, starts a processing and sends the processing result to the client machine.

There are many kinds of services supplied by the server machine. Along with a rapid progress of the Internet, services are diversified and advanced. The number of client machines connected to the server machine also increases.

Furthermore, as networks are improved to correspond to broadband services, the amount of data to be processed also increases and the response time required for each client machine is shortened. While the server machine performance is improved as described above, each server machine comes to be loaded sometimes over the performance. In such a case, the processing in the server machine is delayed significantly. And this often results in rejection of the server machine from processing requests of the client machines. Thus the server machines become a bottleneck of the systems.

There are some methods for solving such a bottleneck. In the first method, the server machine is substituted for a server machine with higher performance. In this case, the bottleneck is eliminated temporarily. However, if the load further increases to generate another bottleneck, the server machine is required to be substituted for another one with still higher performance. And usually, such a server machine with high performance is expensive.

There is another method for solving such problems. According to the second method, a dedicated machine that is different from the server machine processes high load tasks that have been processed by the server machine. According to this method, the server machine selects high load tasks that require many computing power from among those requested to the server machine and passes those high load tasks to the dedicated machine, thereby continuing its processes with use of the results of the high load tasks received from the dedicated machine. However, this method cannot be adopted in some cases and the dedicated machine is expensive.

There is still another method for solving the above problems. The third method uses a plurality of server machines. And this method employs a special node referred to as a load distribution device. The load distribution device controls those server machines of the system. The load distribution device distributes requests received from clients to those server machines so that the system load is distributed evenly among the server machines. If the system load rises and any server becomes a bottleneck, a new server machine is added to the system. And the load distribution device makes the newly added server share the system load to eliminate the bottleneck. In spite of such solutions, this method still has the following problems; the load distribution device is expensive, the load distribution device itself might become a bottle neck, and advanced management is required to distribute the system load.

JP-A No. 2004-220151 (patent document 1) also discloses a technique for solving the above problems. The technique aims at providing a server machine that can update a file without switching any processor to another. The server machine generates a virtual client OS for each started module according to a file start instruction and puts only a modified module in the old file into a new file. And accordingly, all processes are performed in the server machine and only the server machine is loaded by those processes.

There is also another technique disclosed in JP-A No. 11-053326 (patent document 2). The technique makes a client PC take over some of the services supplied from servers without taking any consideration to the client PC machine resources. However, this technique will not be suited for an application program required for communications between a client PC and a server machine 200, since the technique has just changed the places where the application program is executed in that case, that is, from the server machine 200 to the client PC.

Under such circumstances, it is an object of the present invention described in the above embodiments to provide a load reducing system for reducing the load of a server to which accesses are concentrated, with use of a client PC while never lowering the security during the load reducing processing and solve the above described conventional problems.

It is another object of the present invention to provide a load reducing system for reducing the load of the server by using a client machine 100 including a virtual machine (VM).

In the embodiments described above, a server to be used is moved from a server machine to a client machine so that the load of the server machine is reduced. And this server movement is made seamlessly with respect to the client; thereby the client can keep using services supplied from the server without a break. For example, the client machine 100 can take over a high load server tasks such as services in which encryption is required as needed so as to reduce the load of the server.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents of the claimed invention even if the claims are amended during prosecution.

1. A first computer, comprising:
a client manager that sends resource information on resources of said first computer to a second computer, and gets a server generated based on said resource information from said second computer for execution.

2. The first computer in claim 1, further comprising:
a client that is executed by said first computer and makes a communication with said second computer; and
an exchanger that makes a change from said communication with said second computer to a communication with said server.

3. The first computer in claim 2, further comprising:
a first processor that executes said client; and
a second processor that executes said server, wherein:
said exchanger makes said change by changing a communication between said first processor and said second computer to a communication between said first processor and said second processor.

4. The first computer in claim 3, wherein:
said client manager registers an identifier of said second computer as a first identifier and an identifier of said second processor as a second identifier in a forward table; and
said exchanger makes said change by sending a message from said first processor with said first identifier as a destination address to said second processor using said second identifier.

5. The first computer in claim 4, wherein:
said client manager cancels said second processor, deletes said identifier of said second computer and said identifier of said second processor from said forward table to stop said exchanger from making said change when load level of said first computer exceeds a predetermined level.

6. The first computer in claim 4, wherein:
said client manager stops temporally said second processor when load level of said first computer exceeds a first predetermined level and resumes said second processor when load level of said first computer goes below a second predetermined level.

7. The first computer in claim 3, wherein:
said client manager registers an identifier of said first processor as a first identifier and an identifier of said second processor as a second identifier in a forward table; and
said exchanger makes said change by sending a message from said second computer with said first identifier as a destination address to said second processor using said second identifier.

8. A first computer, comprising:
a means for sending resource information on resources of said first computer to a second computer; and
a means for getting a server generated based on said resource information from said second computer for execution.

9. The first computer in claim 8, comprising:
a means for making a communication with said second computer; and
a means for making a change from said communication with said second computer to a communication with said server.

10. A second computer, comprising:
a server manager that receives resource information on resources of a first computer from said first computer; and
a server generator that generates a server based on said resource information and sends said server to said first computer for execution.

11. A second computer, comprising:
a means for receiving resource information on resources of a first computer from said first computer; and
a means for generating a server based on said resource information and sending said server to said first computer for execution.

12. A signal-bearing medium tangibly embodying a program of machine-readable instructions executable by a first computer to perform
a sending process for sending resource information on resources of said first computer to a second computer; and
a getting process for getting a server generated based on said resource information from said second computer for execution.

13. The signal-bearing medium in claim 12, tangibly embodying said program of machine-readable instructions executable by said first computer to perform
a making process for making a change from a communication that a client executed by said first computer makes with said second computer to a communication with said server.

14. The signal-bearing medium in claim 13, wherein said first computer makes said change by changing a communication between a first processor that executes said client and said second computer to a communication between said first processor and a second processor that executes said server.

15. The signal-bearing medium in claim 14, tangibly embodying said program of machine-readable instructions executable by said first computer to perform a registering process for registering an identifier of said second computer as a first identifier and an identifier of said second processor as a second identifier in a forward table wherein said first computer makes said change by sending a message from said first processor with said first identifier as a destination address to said second processor using said second identifier.

16. The signal-bearing medium in claim 15, tangibly embodying said program of machine-readable instructions executable by said first computer to perform
a canceling process for canceling said second processor, delete said identifier of said second computer and said identifier of said second processor from said forward table to stop said first computer from making said change when load level of said first computer exceeds a predetermined level.

17. The signal-bearing medium in claim 15, tangibly embodying said program of machine-readable instructions executable by said first computer to perform
a stopping process for stopping temporally said second processor when load level of said first computer exceeds a first predetermined level and resuming said second processor when load level of said first computer goes below a second predetermined level.

18. A signal-bearing medium tangibly embodying a program of machine-readable instructions executable by a second computer to perform
a receiving process for receiving resource information on resources of a first computer from said first computer; and
a generating process for generating a server based on said resource information and send said server to said first computer for execution.

19. A method for a first computer, comprising:
sending resource information on resources of said first computer to a second computer; and
getting a server generated based on said resource information from said second computer for execution.

20. The method in claim 19, comprising:
making a change from a communication that a client executed by said first computer makes with said second computer to a communication with said server.

21. The method in claim 20, wherein:
said first computer makes said change by changing a communication between a first processor that executes said client and said second computer to a communication between said first processor and a second processor that executes said server.

22. The method in claim 21, comprising:
registering an identifier of said second computer as a first identifier and an identifier of said second processor as a second identifier in a forward table, wherein:
said first computer makes said change by sending a message from said first processor with said first identifier as a destination address to said second processor using said second identifier.

23. A method for a second computer, comprising:
receiving resource information on resources of a first computer from said first computer; and
generating a server based on said resource information and sending said server to said first computer for execution.

24-26. (canceled)

27. A system comprising:
a client manager that sends resource information on resources of said first computer to a second computer, and gets a server generated based on said resource information from said second computer for execution; and
a server manager that that receives resource information on resources of a first computer from said first computer.

28. The system of claim 27, further comprising:
a client that is executed by said first computer and makes a communication with said second computer; and
an exchanger that makes a change from said communication with said second computer to a communication with said server

29. A system comprising:
a means for sending resource information on resources of said first computer to a second computer;
a means for getting a server generated based on said resource information from said second computer for execution;
a means for making a communication with said second computer;
a means for making a change from said communication with said second computer to a communication with said server;
a means for receiving resource information on resources of a first computer from said first computer; and
a means for generating a server based on said resource information and sending said server to said first computer for execution.
